(19) United States
(12) Patent Application Publication
(10) Pub. No.: US 2025/0153288 A1
(43) Pub. Date: May 15, 2025

(54) AUTOMATIC SUPPLY AND ASSEMBLY DEVICE FOR FASTENERS

(71) Applicant: DO LIM INDUSTRY CO., LTD., Ulsan (KR)

(72) Inventors: Sung Gye PARK, Gyeonggi-do (KR); Seong Ju KIM, Ulsan (KR); Young Taek SONG, Ulsan (KR); Young Hun LEE, Ulsan (KR); Nam Kyu KIM, Ulsan (KR); Ki Young KIM, Ulsan (KR); Sang Cho LEE, Ulsan (KR); Ki Yeol KIM, Ulsan (KR)

(21) Appl. No.: 18/941,831

(22) Filed: Nov. 8, 2024

(30) Foreign Application Priority Data
Nov. 10, 2023 (KR) 10-2023-0155478

(51) Int. Cl. B23P 19/00; B23P 19/06

(52) U.S. Cl. CPC B23P 19/001; B23P 19/06

(57) ABSTRACT

Proposed is an automatic supply and assembly device for fasteners, the automatic supply and assembly device being capable of automatically aligning and supplying fasteners and assembling the fasteners. An automatic supply and assembly device for fasteners according to an embodiment includes a main frame, a rail having a guide groove guiding the fasteners, a storage box provided at a second end of the rail and storing the fasteners, a supply unit lifted in the storage box and supplying the fasteners stored in the storage box to the guide groove located at the second end of the rail, a holding plate located apart from a first end of the rail, a withdrawal unit individually withdrawing the fasteners received in the guide groove located at the first end of the rail to the holding plate, and an assembly driver movable upward and downward and assembling a fastener located in the holding plate.

### CROSS REFERENCE TO RELATED APPLICATION

The present application claims priority to Korean Patent Application No. 10-2023-0155478, filed Nov. 10, 2023, the entire contents of which is incorporated herein for all purposes by this reference.

### BACKGROUND OF THE INVENTION

### Field of the Invention

The present disclosure relates to an automatic supply and assembly device for fasteners.

### Description of the Related Art

As an assembly process becomes simplified or unmanned, automatic fastener assembly devices that automatically assemble fasteners (screws, bolts, etc.) using a robot arm are being However, in order for the automatic fastener assembly developed. device to automatically assemble fasteners, the device needs to be able to automatically supply fasteners. For this purpose, a supply device that automatically aligns and supplies fasteners is essential. Korean Patent No. 10-2396391 discloses an automatic bolt fastening device for furniture.

The automatic bolt fastening device for furniture disclosed in this patent document includes: a device body 2 installed with a vertical length relative to the floor; a work table 4 provided on a part of the device body 2, and having a work plate 41 on which a jig means 3 is mounted to support a workpiece 100 in a correct posture; a fastening means 5 provided above the work table 4 on the device body 2 and fastening a bolt 10 by lifting and lowering the bolt 10 while rotating it with respect to the attachment piece 110 that is input onto a surface of the workpiece 100; and a bolt supplier 200 supplying the bolt 10 to the fastening means 5. The fastening means 5 includes: a main lifting body 51 disposed with a gap above the work table 4 on the device body 2; a main lifting member 52 having a lifting driver provided with a lifting motor 521 that is provided on a fixed base 22 of the device body 2 to reciprocate the main lifting body 51 vertically linearly through control of a control means 61 that controls power of a power supplier 62 and is driven by control of the control means 61 to generate a forward and reverse rotational force, and a lifting screw rod 523 that is screw-connected with a lifting nut tube 522 provided on the main lifting body 51 and is rotated forward and backward to selectively lift and lower the main lifting body 51 by receiving the rotational force from the lifting motor 521; a supply member 55 provided under a rotary tube 54, connected to an inlet tube 552 that receives the bolt 10 supplied to one side, and having a supply tube 551 having a sleeve shape with open upper and lower ends and allowing the bolt 10 introduced therein to be aligned in an upright state, the rotary tube 54 having a sleeve shape with open upper and lower ends, being coupled to the main lifting body 51, and receiving a rotary rod 53 therein that is coupled to a screw head of the bolt 10 to rotate the bolt 10; a a rotary member 57 having a rotary connector that transmits rotational force generated from a rotary motor 56 through control of the control means 61 to the rotary rod 53 disposed inside the rotary tube 54 to selectively rotate the rotary rod 53; an auxiliary lifting body 58 disposed with a gap above the main lifting body 51 on the device body 2 and to which the rotary member 57 is fixed; and an auxiliary lifting member 59 having an auxiliary lifting drive that vertically reciprocates the auxiliary lifting body 58 through control of the above control means 61 to selectively lift and lower the rotary member 57 and lift and lower the rotary rod 53 inside the rotary tube 54.

The bolt supplier of the automatic bolt fastening device for furniture align bolts while rotating a cylinder storing the bolts continuously at a constant speed, and thus is problematic in that it takes a long time to supply the bolts and the bolt supplier is bulky.

The foregoing is intended merely to aid in the understanding of the background of the present disclosure, and is not intended to mean that the present disclosure falls within the purview of the related art that is already known to those skilled in the art.

### Documents of Related Art

(Patent document 1) Korean Patent No. 10-2396391 (registered on May 4, 2022)

### SUMMARY OF THE INVENTION

Accordingly, the present disclosure has been made keeping in mind the above problems occurring in the related art, and one objective of the present disclosure is to provide an automatic supply and assembly device for fasteners, the automatic supply and assembly device being capable of automatically aligning and supplying fasteners and assembling the fasteners.

In order to achieve the above objective, according to one aspect of the present disclosure, there is provided an automatic supply and assembly device for fasteners, the automatic supply and assembly device including: a main frame; a rail having a first side coupled to a lower end of the main frame and a second side inclined so as to be located higher than the first side, and having a guide groove formed longitudinally on an upper side thereof and configured to guide the fasteners; a storage box provided at a second end of the rail and configured to store the fasteners therein; a supply unit configured to be lifted in the storage box and supply the fasteners stored in the storage box to the guide groove located at the second end of the rail; a holding plate coupled to the lower end of the main frame and located apart from a first end of the rail; a withdrawal unit coupled to the lower end of the main frame and configured to individually withdraw one by one the fasteners received in the guide groove located at the first end of the rail to the holding plate; and an assembly driver coupled to the main frame so as to be movable upward and downward and configured to assemble a fastener located in the holding plate by lowering the fastener.

Additionally, the supply unit of the automatic supply and assembly device may include: a fan-shaped plate coupled to a lower portion of the second side of the rail, with an arc portion thereof facing downward; a rotary bar having a first side located outside the fan-shaped plate and a second side axially coupled to a center of the fan-shaped plate so as to be rotatable; and a rotary plate having a first side coupled to the first side of the rotary bar and a second side located in the storage box, and having a receiving groove formed on the second side thereof and configured to allow the fasteners to be received therein.

Additionally, the withdrawal unit of the automatic supply and assembly device may include: a rotary frame axially coupled to the lower end of the main frame; a leg frame extending downward from the rotary frame; and a stopper coupled to an end of the leg frame and configured to restrict movement of the fasteners located at the first end of the rail.

Additionally, the automatic supply and assembly device may further include: an alignment unit located above the rail and configured to be moved along the rail to align the fasteners received in the guide groove.

Additionally, the alignment unit of the automatic supply and assembly device may include: a sliding bar located above the rail and configured to be movable along the rail; a pusher located above the second end of the rail and coupled to the sliding bar; and a groove formed in the pusher and having a shape corresponding to each of the fasteners.

In the automatic supply and assembly device for fasteners according to the embodiment, when the fasteners stored in the storage box are lifted by the rotary plate, only the fasteners received in the receiving groove of the rotary plate can be guided to the guide groove. This enables easy supply of the fasteners to the rail.

Additionally, in the automatic supply and assembly device for fasteners according to the embodiment, only the fasteners received in the guide groove and the receiving groove can be guided to the rail due to reciprocating motion of the alignment unit and the groove of the alignment unit. This enables easy alignment of the fasteners.

Additionally, the automatic supply and assembly device for fasteners according to the embodiment can supply the fasteners to the rail without malfunction due to its simple structure.

Additionally, the automatic supply and assembly device for fasteners according to the embodiment can have a smaller volume than a conventional supply device, so it can be installed together with a robot arm, and it does not require much installation space and can be installed even in a narrow space area.

### BRIEF DESCRIPTION OF THE DRAWINGS

The above and other objectives, features, and other

advantages of the present disclosure will be more clearly understood from the following detailed description when taken in conjunction with the accompanying drawings, in which:

FIG. 1 is a perspective view illustrating an automatic supply and assembly device for fasteners according to an embodiment;

FIG. 2 is an exploded view illustrating the automatic supply and assembly device for fasteners according to the embodiment;

FIG. 3 is a view illustrating a state in which fasteners are supplied by the automatic supply and assembly device for fasteners according to the embodiment;

FIG. 4 is a view illustrating a state in which the

fasteners are supplied by the automatic supply and assembly device for fasteners according to the embodiment;

FIG. 5 is a view illustrating a state in which the fasteners are assembled by the automatic supply and assembly device for fasteners according to the embodiment;

FIG. 6 is a view illustrating a state in which the fasteners are assembled by the automatic supply and assembly device for fasteners according to the embodiment; and

FIG. 7 is a view illustrating a state in which the fasteners are assembled by the automatic supply and assembly device for fasteners according to the embodiment.

### DETAILED DESCRIPTION OF THE INVENTION

The present disclosure, advantages of the present disclosure, and objectives achieved by the present disclosure will become apparent from the detailed description of the following embodiments in conjunction with the accompanying drawings. However, it should be understood that the present disclosure is not limited to the following embodiments and may be embodied in different ways, and that the embodiments are given to provide complete disclosure of the inventive concept and to provide a thorough understanding of the present disclosure to those skilled in the art. The scope of the present disclosure is defined only by the claims. Throughout the drawings, the same reference numerals will refer to the same or like parts.

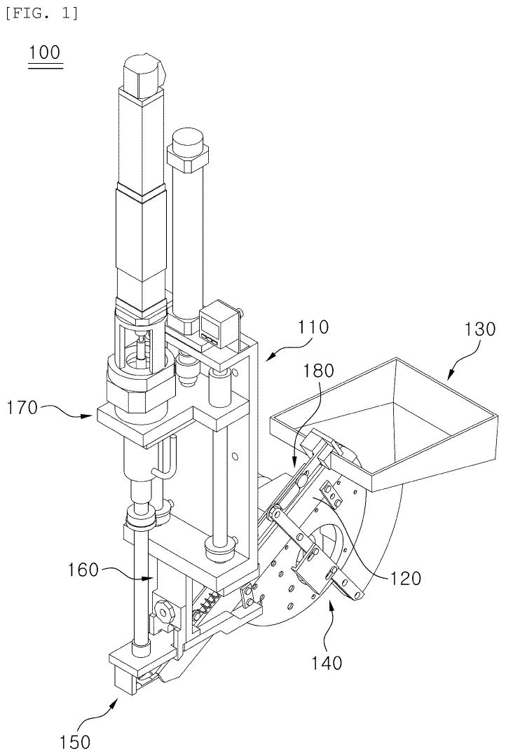

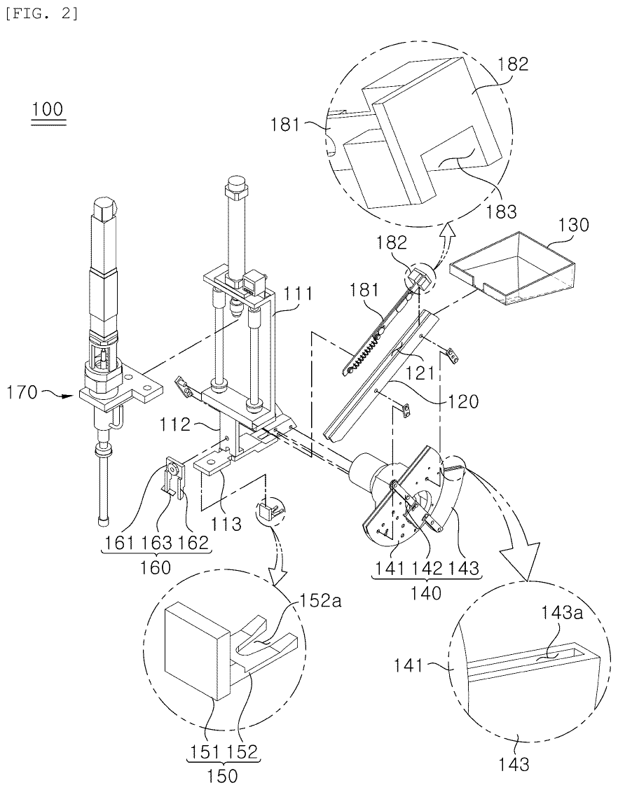

Referring to FIG. 1, which is a perspective view of an automatic supply and assembly device 100 for fasteners according to an embodiment (hereinafter referred to as “automatic supply and assembly device 100 for fasteners”, and FIG. 2, which is an exploded view of the automatic supply and assembly device 100 for fasteners, the automatic supply and assembly device 100 for fasteners includes a main frame 110, a rail 120, a storage box 130, a supply unit 140, a holding plate 150, a withdrawal unit 160, and an assembly driver 170.

The main frame 110 may be configured as frames having various shapes, and may be mounted on a tip of a robot arm so as to be movable by the robot arm. As an example, the main frame 110 may include a first frame 111, a second frame 112, and a third frame 113.

The first frame 111 is a “⊏” shaped frame. A body portion of the first frame 111 is mounted on the tip of the robot arm while opposite ends of the first frame 111 are located in the vertical direction. A first end of the first frame 111 may be located upward and may be provided with various sensors such as a photo sensor and an approach detection sensor.

The second frame 112 extends downward from a second end of the first frame 111. The second frame 112 may have a narrower area than the first frame 111. The third frame 113 is coupled orthogonal to the second

frame 112. That is, the third frame 113 is in a horizontal state. The third frame 113 has a hole formed on a side thereof to allow an end of the assembly driver 170, which will be described later, to pass therethrough.

The rail 120 is inclined so that a first side thereof is coupled to a lower end of the main frame 110 and a second side thereof is located higher than the first side thereof. Additionally, the rail 120 has a guide groove 121 formed longitudinally on an upper side thereof to guide fasteners F. Accordingly, the fasteners F received in the guide groove 121 are guided from the second side to the first side of the rail 120 by gravity.

The guide groove 121 has a width capable of receiving a body FB of each of the fasteners F, and a head FH of each of the fasteners F is not received in the guide groove 121.

The storage box 130 is provided at a second end of the rail 120 and stores the fasteners F therein. The storage box 130 has a slit formed at a lower portion thereof to allow a second side of a rotary plate 143 of the supply unit 140, which will be described later, to pass therethrough.

The supply unit 140 is lifted inside the storage box 130 and supplies the fasteners F stored in the storage box 130 to the guide groove 121 located at the second end of the rail 120. As an example, the supply unit 140 may include a fan-shaped plate 141, a rotary bar 142, and the rotary plate 143.

The fan-shaped plate 141 is coupled to a lower portion of the second side of the rail 120, with an arc portion thereof facing downward. The fan-shaped plate 141 may have a semicircular shape to correspond to the rail 120.

The rotary bar 142 has a first side located outside the fan-shaped plate 141 and a second side axially coupled to the center of the fan-shaped plate 141. That is, the first side of the rotary bar 142 is moved along the arc portion of the fan-shaped plate 141 with the center of the fan-shaped plate 141 as the axis.

The rotary plate 143 has a first side coupled to the first side of the rotary bar 142 and a second side located in the lower slit of the storage box 130. Additionally, the rotary plate 143 has a receiving groove 143a formed on the second side thereof to receive the fasteners F. The receiving groove 143a has a width capable of receiving the body FB of each of the fasteners F, and the head FH of each of the fasteners F is not received in the receiving groove 143a.

As an example, the rotary plate 143 may have a shape corresponding to a lateral surface of a truncated cone in a development drawing of the truncated cone, with a first slant side coupled to the first side of the rotary bar 142 and a second slant side located in the lower slit of the storage box 130. At this time, a short curved portion of the rotary plate 143 has the same curvature as the arc portion of the fan-shaped plate 141. Additionally, when the rotary plate 143 is lifted to its maximum height, the second slant side of the rotary plate 143 forms a straight line with the rail 120 so that the receiving groove 143a and the guide groove 121 communicate with each other. Accordingly, the rotary plate 143 is lifted inside the storage box 130 by rotation of the rotary bar 142 while the fasteners F are received in the receiving groove 143a, and the fasteners F received in the receiving groove 143a are supplied to the guide groove 121 located on the second side of the rail 120 by gravity.

The holding plate 150 is coupled to the lower end of the main frame 110 and is located apart from a first end of the rail 120. As an example, the holding plate 150 may include an extension plate 151 and a leg plate 152.

The extension plate 151 is formed to extend downward from the third frame 113 of the main frame 110 and is located apart from the first end of the rail 120.

The leg plate 152 is located directly below the third frame 113 and is hinged to an end of the extension plate 151 so as to be rotatable downward in a horizontal state. Additionally, the leg plate 152 has a holding groove 152a for receiving the body FB of each of the fasteners F. The holding groove 152a is formed by opening a side of the leg plate 152 facing the first end of the rail 120.

The withdrawal unit 160 is coupled to the lower end of the main frame 110 and individually withdraws one by one the fasteners F received in the guide groove 121 located at the first end of the rail 120 to the holding plate 150. The withdrawal unit 160 includes a rotary frame 161, a leg frame 162, and a stopper 163.

The rotary frame 161 is axially coupled to the second frame 112 of the main frame 110.

The leg frame 162 extends downward from the rotary frame 161.

The stopper 163 is coupled to an end of the leg frame 162 and has an end located in the guide groove 121 located on the first side of the rail 120. The stopper 163 restricts movement of the fasteners F received in the guide groove 121 located at the first end of the rail 120 by being inserted into or removed from the guide groove 121 located at the first end of the rail 120 by rotation of the rotary frame 161.

The assembly driver 170 is coupled to the main frame 110 so as to be movable upward and downward, and has an end located directly above the holding groove 152a of the holding plate 150. The assembly driver 170 is moved downward to receive a fastener F located in the holding plate 150 and assemble the fastener F to a workpiece. The assembly driver 170 may be moved upward and downward by a hydraulic cylinder provided on the main frame 110.

Additionally, the automatic supply and assembly device 100 for fasteners may further include an alignment unit 180.

The alignment unit 180 is located above the rail 120 and is moved along the rail 120 to align the fasteners F received in the guide groove 121. As an example, the alignment unit 180 includes a sliding bar 181, a pusher 182, and a groove 183.

The sliding bar 181 is located above the rail 120 and is movable along the rail 120.

The pusher 182 is located above the second end of the rail 120 and is coupled to the sliding bar 181 so as to movable along the rail 120 together with the sliding bar 181.

The groove 183 is formed in the pusher 182 and has a shape corresponding to the head FH of each of the fasteners F. Accordingly, the pusher 182 is reciprocally moved by the sliding bar 181, thereby aligning the fasteners F by pushing out the fasteners F coming out of the guide groove 121 located on the second side of the rail 120. That is, only the fasteners F in which the body FB is received in the guide groove 121 and the head FH passes through the groove 183 remain, and the remaining fasteners F are dropped back into the storage box 130 by the pusher 182.

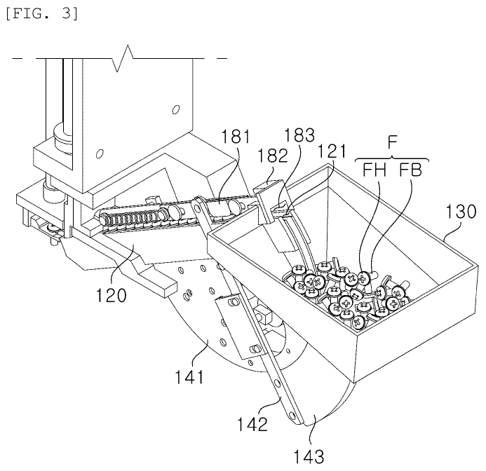

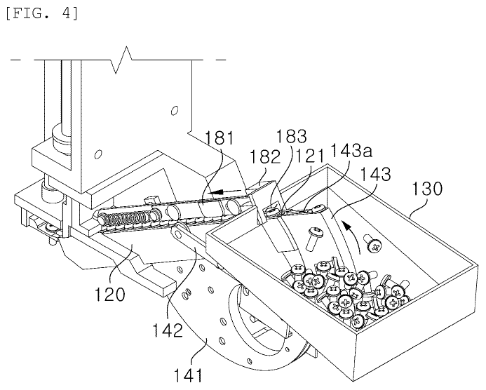

A process of aligning and supplying the fasteners F by the automatic supply and assembly device 100 for fasteners will be described with reference to FIGS. 3 and 4. FIG. 3 illustrates a state before the fasteners F are aligned and supplied by the automatic supply and assembly device 100 for fasteners, and FIG. 4 illustrates a state in which the fasteners F are aligned and supplied by the automatic supply and assembly device 100 for fasteners.

Referring to FIG. 3, the second side of the rotary plate

143 is located inside the storage box 130 and buried in the fasteners F, while the pusher 182 is pushed to the second end of the rail 120. As the pusher 182 is moved to the second end of the rail 120, the pusher 182 pushes out the fasteners F that are not received in the receiving groove 143a of the rotary plate 143 and drops them into the storage box 130.

Referring to FIG. 4, the second side of the rotary plate 143 is lifted by the rotary bar 142, while the pusher 182 is moved toward the first side of the rail 120. As the rotary plate 143 is lifted, the fasteners F placed on the second side of the rotary plate 143 or received in the receiving groove 143a of the rotary plate 143 are lifted together with the rotary plate 143. Thereafter, the fasteners F received in the receiving groove 143a of the rotary plate 143 are moved to the guide groove 121 of the rail 120 by inclination of the second side of the rotary plate 143, and the fasteners F not received in the receiving groove 143a are not guided to the guide groove 121, but are dropped into the storage box 130 by the pusher 182 when the automatic supply and assembly device 100 for fasteners returns to the state of FIG. 3.

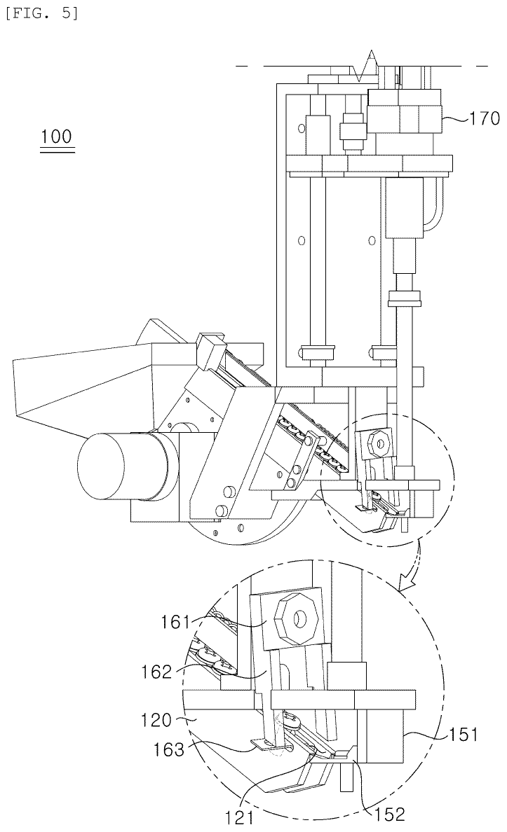

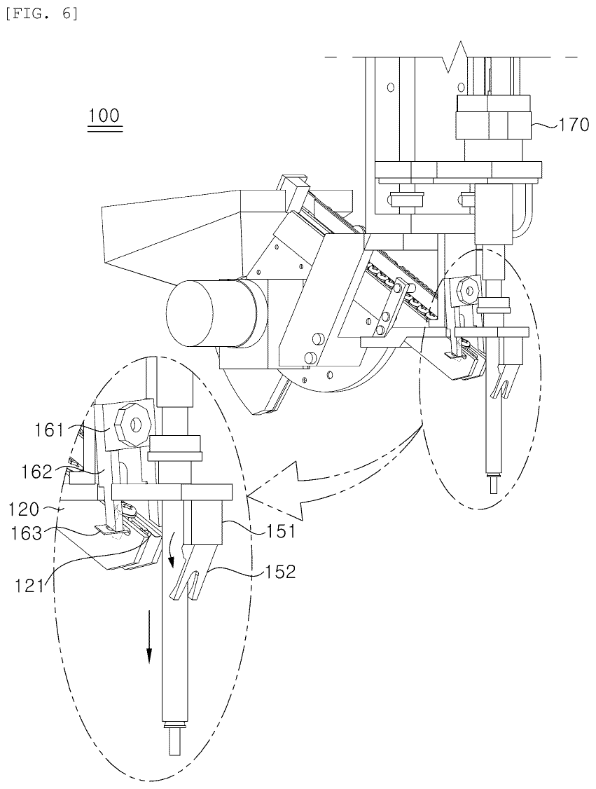

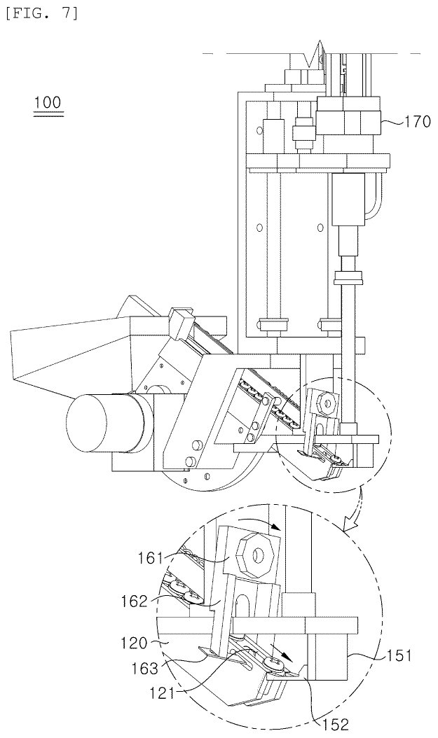

A process of assembling the fasteners F by the automatic supply and assembly device 100 for fasteners will be described with reference to FIGS. 5 to 7. FIG. 5 illustrates a state before the assembly driver 170 is lowered, and FIG. 6 illustrates a state in which the assembly driver 170 is lowered. FIG. 7 illustrates a state in which the assembly driver 170 is lifted and the fasteners F are individually withdrawn to the holding plate 150.

Referring to FIG. 5, the end of the assembly driver 170 is located above the holding plate 150, while the leg plate 152 of the holding plate 150 is in a horizontal state. Also, the fasteners F received in the guide groove 121 located at the first end of the rail 120 are restricted from moving by the stopper 163 of the withdrawal unit 160.

Referring to FIG. 6, the end of the assembly driver 170 is lowered, thereby assembling each of the fasteners F located in the holding plate 150 to the workpiece. At this time, the assembly driver 170 is lowered without interference as the leg plate 152 of the holding plate 150 is rotated downward, while the fasteners F received in the guide groove 121 located at the first end of the rail 120 are still restricted from moving by the stopper 163 of the withdrawal unit 160.

Referring to FIG. 7, as the end of the lowered assembly driver 170 is lifted, the leg plate 152 of the holding plate 150 is rotated to its original position. Thereafter, as the rotary frame 161 of the withdrawal unit 160 is rotated, the stopper 163 is removed from the guide groove 121, and one of the fasteners F received in the guide groove 121 located at first end of the rail 120 is supplied to the holding plate 150.

The expressions (terms, visualized images, etc.) used in describing the embodiment of the present disclosure have been merely selected for purpose of enhancing understanding of the technology.

Although the present disclosure has been described by a limited number of embodiments and drawings, a person of ordinary skill in the art will be capable of making various modifications and changes from the above embodiments.

Accordingly, the scope of the present disclosure should not be limited by some expressions appearing in the “DETAILED DESCRIPTION OF THE INVENTION” and the “DRAWINGS”, but should be broadly interpreted on the basis of the original technical ideas inherent in the entire specification.

What is claimed is:

1. An automatic supply and assembly device for fasteners, the automatic supply and assembly device comprising:
a main frame;
a rail having a first side coupled to a lower end of the main frame and a second side inclined so as to be located higher than the first side, and having a guide groove formed longitudinally on an upper side thereof and configured to guide the fasteners;
a storage box provided at a second end of the rail and configured to store the fasteners therein;
a supply unit configured to be lifted in the storage box and supply the fasteners stored in the storage box to the guide groove located at the second end of the rail;
a holding plate coupled to the lower end of the main frame and located apart from a first end of the rail;
a withdrawal unit coupled to the lower end of the main frame and configured to individually withdraw one by one the fasteners received in the guide groove located at the first end of the rail to the holding plate; and
an assembly driver coupled to the main frame so as to be movable upward and downward and configured to assemble a fastener located in the holding plate by lowering the fastener.

2. The automatic supply and assembly device of claim 1, wherein the supply unit comprises:
a fan-shaped plate coupled to a lower portion of the second side of the rail, with an arc portion thereof facing downward;
a rotary bar having a first side located outside the fan-shaped plate and a second side axially coupled to a center of the fan-shaped plate so as to be rotatable; and
a rotary plate having a first side coupled to the first side of the rotary bar and a second side located in the storage box, and having a receiving groove formed on the second side thereof and configured to allow the fasteners to be received therein,
wherein the rotary plate is lifted inside the storage box by rotation of the rotary bar and supplies the fasteners received in the receiving groove to the guide groove located at the second end of the rail.

3. The automatic supply and assembly device of claim 1, wherein the withdrawal unit comprises:
a rotary frame axially coupled to the lower end of the main frame;
a leg frame extending downward from the rotary frame; and
a stopper coupled to an end of the leg frame and configured to restrict movement of the fasteners located at the first end of the rail,
wherein the stopper restricts movement of the fasteners received in the guide groove located at the first end of the rail by being inserted into or removed from the guide groove located at the first end of the rail by rotation of the rotary frame.

4. The automatic supply and assembly device of claim 1, further comprising:
an alignment unit located above the rail and configured to be moved along the rail to align the fasteners received in the guide groove.

5. The automatic supply and assembly device of claim 4, wherein the alignment unit comprises:
a sliding bar located above the rail and configured to be movable along the rail;
a pusher located above the second end of the rail and coupled to the sliding bar; and
a groove formed in the pusher and having a shape corresponding to each of the fasteners,
wherein the pusher aligns the fasteners by pushing out the fasteners coming out of the guide groove by movement of the sliding bar.
